(19) United States
(12) Patent Application Publication
(10) Pub. No.: US 2007/0274549 A1
(43) Pub. Date: Nov. 29, 2007

(54) Hearing apparatus having an oscillator circuit and corresponding method

(75) Inventor: Kunibert Husung, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AUDIOLOGISCHE TECHNIK GMBH

(21) Appl. No.: 11/804,668

(22) Filed: May 18, 2007

(30) Foreign Application Priority Data
May 26, 2006 (DE) 10 2006 024 713.2

(51) Int. Cl. H04R 25/00

(52) U.S. Cl. 381/312; 381/323

(57) ABSTRACT

Hearing apparatuses and in particular hearing devices are to be designed to be smaller. To this end, a hearing apparatus having a housing and a coil arranged in the housing are proposed. A current detection facility is connected to the coil in order to detect a current flowing through the coil. An oscillator circuit, which is located outside the housing and which can be energized to oscillate with the aid of the coil, can be moved closer to the hearing apparatus in order to switch or control it. The current flowing through the coil to energize oscillations is then detected by the current detection facility for controlling the hearing apparatus. A hearing device is thus able to switch itself on and off without the need for a mechanical switch.

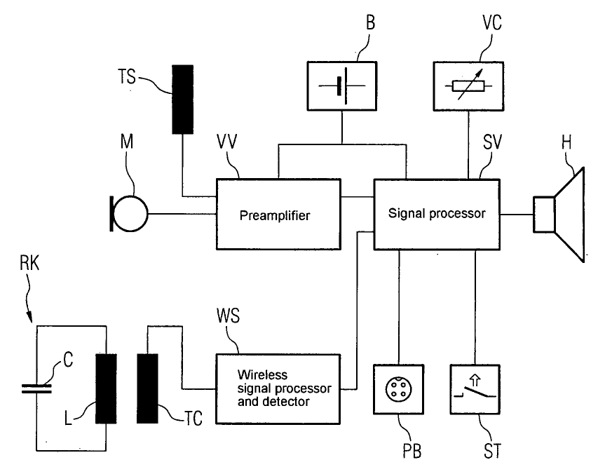

### CROSS REFERENCE TO RELATED APPLICATIONS

This application claims priority of German application No. 10 2006 024 713.2 filed May 26, 2006, which is incorporated by reference herein in its entirety.

### FIELD OF THE INVENTION

The present invention relates to a hearing apparatus having a housing and a coil arranged in said housing for wireless transmission. Furthermore, the present invention relates to a method for controlling a hearing apparatus. The term hearing apparatus is understood here to mean in particular a hearing device. However, headsets, headphones and suchlike also come under this term.

### BACKGROUND OF THE INVENTION

Hearing aid devices are generally switched off and on by means of corresponding switches and/or push-buttons. Suitable switches for this are sliding switches, rotary switches or battery compartment switches. These switching elements however require installation space in the device, which is frequently not available by virtue of the small dimensions of the devices. In the case of a battery compartment switch, a further problem exists in that in some circumstances said battery compartment switch can no longer be operated when an audio shoe is attached.

To avoid voluminous switches, hearing aid devices having integrated reed contacts also exist, so that the hearing aid devices can be switched on and off from the outside using permanent magnets. The magnet used in each instance for switching purposes is located in a storage box of the hearing aid device for instance. The device is placed in this box and thus switched off when it is not in use.

DE 31 09 049 C2 discloses a hearing device having a reed contact switch which is insensitive to external interferences.

### SUMMARY OF THE INVENTION

The object of the present invention consists in likewise proposing a non-contact switch-off possibility for a hearing apparatus, with a further miniaturization of the hearing apparatus optionally being possible. In accordance with the invention, this object is achieved by a hearing apparatus having a housing and a coil arranged in said housing, as well as a current detection facility connected to the coil for detecting a current flowing through the coil and an oscillator circuit, which is located outside the housing and which can be energized to oscillate with the aid of the coil, with the current flowing through the coil to energize oscillations being detected by the current detection facility to control the hearing apparatus.

Furthermore, a method is provided in accordance with the invention for controlling a hearing apparatus by moving an oscillator circuit in relation to a coil of the hearing apparatus, detecting a current through the coil, which is used to energize the oscillator circuit and which changes as a function of the distance between the coil and the oscillator circuit, and controlling the hearing apparatus as a function of the detected current.

The concept underlying the invention is to use the principle used in anti-theft systems in department stores involving electronically securing goods to switch and/or control hearing apparatuses. In the case of an anti-theft system, an alarm is triggered when a goods label, which contains a printed circuit made up of an inductor and a capacitor, passes the exit. The resonance circuit formed from the inductor and the capacitor is matched precisely to a transmitter coil located at the exit. The electronic label draws energy from the transmitter, thus resulting in an increase in current consumption in the transmitter. The current change is evaluated and results in the alarm being triggered. This principle is advantageously used to wirelessly switch and/or control the hearing apparatus. With hearing devices in particular, it is possible to use electronic components which are already integrated in the hearing device. In this case in particular, this allows the installation size of the hearing device to be reduced, since there is no need for special circuit components in the hearing device to switch said hearing device on and off.

The coil of the hearing apparatus is preferably a transceiver coil for communication with a further hearing apparatus. The transceiver coil is in particular the inductive element, which is installed in each hearing device where there is binaural coverage, so that these two hearing devices can communicate with one another.

The current detection facility can be part of an integrated switching circuit of the hearing apparatus. This also saves space in the hearing apparatus.

It is furthermore advantageous if the hearing apparatus comprises a switching element for switching the hearing apparatus on/off, with the switching element being switched as a function of the detected current. In this context the switching element is able to switch the hearing apparatus off, when the detected current exceeds a predetermined first threshold value. Furthermore, the switching element is able to switch the hearing apparatus on, when the detected current is below a predetermined second threshold value.

In addition to this pure switching on and off, the oscillator circuit can also be used to switch the hearing apparatus over. A hearing device can be switched to another hearing device program for instance. In a further refined embodiment, the current intensity of the current flowing through the coil is detected quantitively and a parameter of the hearing apparatus is controlled as a function of current intensity. It is thus possible for instance to control the volume and/or amplification of a hearing device, by moving the oscillator circuit to the desired distance from the hearing device for a specific time. Continuous control of the hearing apparatus by means of wireless technology is thus also possible.

According to an advantageous development of the hearing apparatus according to the invention, the oscillator circuit is integrated in a storage box for the hearing apparatus. In this case, the hearing apparatus is switched off, when it is located in the storage box and is not in use. This avoids the situation where the user forgets to turn the hearing apparatus off when not in use.

### BRIEF DESCRIPTION OF THE DRAWINGS

The present invention is now described in more detail below with reference to the appended drawing, which shows a schematic diagram of a hearing aid device according to the invention.

### DETAILED DESCRIPTION OF THE INVENTION

The exemplary embodiments described in more detail below represent preferred embodiments of the present invention.

The circuit diagram presented in the FIG shows inter alia the basic components of a hearing aid device. According to this, a microphone M records the sound and forwards a corresponding input signal to a preamplifier VV. This preamplifier VV contains an A/D converter and a voltage regulator. A telephone coil TS, which records inductive signals from the telephones, is used as a further input source.

The output signal of the preamplifier is forwarded to a digital signal processor SV with a clocked final stage. Together with the preamplifier this is supplied with energy from a battery B. Furthermore, the signal processor SV receives an actuating signal from an actuator VC for volume adjustment purposes. Furthermore, the digital signal processor SV can also be controlled by a situation key ST. It is herewith possible to switch to a corresponding hearing device program according to the hearing situation. Furthermore, the digital signal processor SV can be supplied with programming data by way of a programming socket PB. The output signal of the digital signal processor is finally fed to an earpiece H.

Furthermore, the hearing aid device illustrated by way of example in the FIG is equipped with a transceiver coil TC, by means of which communication with another hearing device is possible for instance. The transceiver coil TC is evaluated and/or controlled by way of a wireless signal processor WS, which is linked to the central signal processor SV. The radio transmission is carried out at a specific frequency.

In accordance with the invention, an oscillator and/or resonance circuit RK comprising an inductor L and a capacitor C, matched to the working frequency of the transmission system, is moved with the transceiver coil TC into direct proximity to the transmitter, i.e. the transceiver coil TC. Energy is herewith drawn from the transmitter. This physical effect is now used to switch the hearing aid device off in a defined manner.

The transceiver coil TC thus receives the additional functionality of a transmitter for an IF switch. To simplify matters, the detector required to detect the current and/or the current intensity through the transceiver coil TC is integrated here into the wireless signal processor WS. The detector can thus be used together with the transceiver coil TC and the resonance circuit RK as an HF switch.

The resonance circuit RK is favorably integrated into the storage box of the hearing aid device. If a switched-on hearing aid device is then placed in the box, it is switched off utilizing the above-described effect. If the device is taken back out of the box, no more energy is drawn from the transceiver coil, so the hearing aid device is automatically switched on again. In the switched-off state, the monitoring circuit only requires a minimal standby current.

In the case of the wireless communication between two hearing devices (e²e Wireless), an evaluation circuit for detecting the transmission current flowing through the transceiver coil TC is usually already integrated in the wireless signal processor WS. Calibration of the current through the coil is herewith possible. This current detection unit can now also be used for current detection when switching with the external resonance circuit RK, so that no additional coil and hardly any additional evaluation circuit elements are needed for this wireless switching according to the invention. The additional elements needed for switching can be integrated in the existing TC of the hearing aid apparatus.

Since the circuit breaker, as an actuation element, only requires one resonance circuit, no individual current supply is needed for the actuation element. In addition the resonance circuit only results in minimal costs.

If the inventive HF switch is used to switch the hearing aid device on and off, a magnetic switch for switching to a telephone program can also be used for instance, since the two switches do not mutually influence one another. Interference immunity in respect of other electronic components can also be ensured by correspondingly high frequency selectivity, namely by selecting the quality of the resonance circuit to be suitably high.

The HF switch enables a mechanical switch to be dispensed with, as a result of which the frequency of repairs generally also drops. This saving further results in smaller devices, with the result that the HF switch is particularly advantageous in the case of in-the-ear hearing devices having e²e technology.

1.-10. (canceled)

11. A hearing apparatus, comprising:
a housing;
a coil arranged in the housing;
a current detection device connected to the coil that detects a current flowing through the coil; and
an oscillator circuit located outside the housing that is powered by the current and controls the hearing apparatus as a function of the current.

12. The hearing apparatus as claimed in claim 11, wherein the coil is a transceiver coil for communicating with a further hearing apparatus.

13. The hearing apparatus as claimed in claim 11, wherein the current detection device is arranged in the housing.

14. The hearing apparatus as claimed in claim 11, wherein the current detection device is a part of an integrated switching circuit of the hearing apparatus.

15. The hearing apparatus as claimed in claim 11, further comprising a switching element for switching the hearing apparatus on and off.

16. The hearing apparatus as claimed in claim 15, wherein the switching element switches the hearing apparatus on and off based on the detected current.

17. The hearing apparatus as claimed in claim 16, wherein the switching element switches the hearing apparatus off if the detected current exceeds a predetermined first threshold value.

18. The hearing apparatus as claimed in claim 16, wherein the switching element switches the hearing apparatus on if the detected current is below a predetermined second threshold value.

19. The hearing apparatus as claimed in claim 11, wherein the oscillator circuit is integrated in a storage box for the hearing apparatus.

20. The hearing apparatus as claimed in claim 11, wherein the hearing apparatus is a hearing aid device.

21. A method for controlling a hearing apparatus, comprising:
moving an oscillator circuit with respective to a coil of the hearing apparatus;
powering the oscillator circuit by a current through the coil;
detecting the current that changes as a function of a distance between the coil and the oscillator circuit; and
controlling the hearing apparatus as a function of the detected current.

22. The method as claimed in claim 21, wherein the coil is a transceiver coil for communicating with a further hearing apparatus.

23. The method as claimed in claim 21, wherein the coil is arranged in the hearing apparatus.

24. The method as claimed in claim 21, wherein the oscillator circuit is located outside the hearing apparatus.

25. The method as claimed in claim 21, wherein the current is detected by a current detection device.

26. The method as claimed in claim 25, wherein the current detection device is arranged in the housing.

27. The method as claimed in claim 25, wherein the current detection device is a part of an integrated switching circuit of the hearing apparatus.

28. The method as claimed in claim 21, wherein the oscillator circuit is integrated in a storage box for the hearing apparatus.

29. The method as claimed in claim 21, wherein the hearing apparatus is switched off if the detected current exceeds a predetermined first threshold value.

30. The method as claimed in claim 21, wherein the hearing apparatus is switched on if the detected current is below a predetermined second threshold value.
